(19) United States
(12) Patent Application Publication
(10) Pub. No.: US 2017/0141598 A1
(43) Pub. Date: May 18, 2017

(54) ELECTRIC BATTERY COMPRISING AN ELECTRONIC MANAGEMENT SYSTEM

(71) Applicant: Commissariat à I'Energie Atomique et aux Energies Alternatives, Paris (FR)

(72) Inventor: Matthieu DESBOIS-RENAUDIN, Villard de Lans (FR)

(21) Appl. No.: 15/350,079

(22) Filed: Nov. 13, 2016

(30) Foreign Application Priority Data
Nov. 17, 2015 (FR) 1561041
Nov. 9, 2016 (EP) 16198047.9

(51) Int. Cl. H02J 7/00; H01M 10/48; H01M 10/42

(52) U.S. Cl. CPC H02J 7/0081; H02J 7/0068; H01M 10/425; H01M 10/482; H01M 2010/4271

(57) ABSTRACT

A battery including: a plurality of electrical energy storage units; associated with each unit, an interconnection circuit including first and second switches series-connected between a positive terminal and a negative terminal of the unit, the second switches of the different interconnection circuits being series-connected between a positive terminal and a negative terminal of the battery; associated with each interconnection circuit, a self-contained control circuit capable of causing the turning off of the first switch and the turning on of the second switch to shunt the unit; and a management unit connected to the positive and negative terminals of the system, capable, when a unit is shunted, of detecting a corresponding voltage drop between the positive and negative terminals of the battery, and of accordingly controlling the current flowing through the battery.

### CROSS-REFERENCE TO RELATED APPLICATION

This application claims the priority benefit of French patent application number 15/61041, the content of which is hereby incorporated by reference in its entirety to the maximum extent allowable by law.

### BACKGROUND

The present disclosure relates to an electric battery comprising a plurality of electrical energy storage cells and an electronic battery management system.

### DISCUSSION OF THE RELATED ART

An electric battery conventionally comprises a plurality of identical or similar rechargeable electrical energy storage cells (cells, accumulators, supercapacitors, etc.) coupled in series and/or in parallel between two respectively positive and negative voltage supply terminals. During battery discharge phases, a current flows from the positive terminal to the negative terminal of the battery, through a load to be powered. During battery recharge phases, a charger applies a recharge current flowing from the negative terminal to the positive terminal of the battery (through the charger).

A battery further generally comprises an electronic management system capable of implementing battery recharge control, discharge control, and/or cell balancing operations. Conventionally, the electronic management system comprises, associated with each cell, one or a plurality of sensors capable of measuring one or a plurality of physical parameters of the cell, for example, its voltage or its temperature. The sensors communicate with a centralized control unit which takes into account the measured values to accordingly order actions such as the decrease or the interruption of the battery recharge or discharge current, or battery cell balancing actions.

A problem which arises is that of the reading of the output values of the management device sensors, and of the transmission of the read values to the centralized control unit.

To perform this reading, a wire connection connecting each sensor to the control unit may be provided. The number of cables and the length of the cables of the management device are then high, which results in a high cost of the battery and in multiplied risks of failure. Further, when the battery cells are coupled in series and each sensor has, as a power supply voltage, the cell voltage associated therewith, the output values of the different sensors may be referenced with respect to different potentials, sometimes relatively distant. Galvanic isolation devices should then be provided between the sensor outputs and the control unit, which further increases the complexity and the cost of the battery.

Other communication systems have been provided, such as wireless communication systems, or also carrier current communication systems using the battery power path to transmit the sensor output values. Such systems have various disadvantages, and particularly those of being complex and expensive.

### SUMMARY

Thus, an embodiment provides an electric battery comprising: a plurality of electrical energy storage units; associated with each unit, an interconnection circuit comprising first and second switches series-connected between a positive terminal and a negative terminal of the unit, the second switches of the different interconnection circuits being series-connected between a positive terminal and a negative terminal of the battery; associated with each interconnection circuit, a self-contained control circuit capable of causing the turning off of the first switch and the turning on of the second switch to shunt the unit when the voltage across the unit reaches a threshold; and a management unit connected to the positive and negative terminals of the system, capable, when a unit is shunted, of detecting a corresponding voltage drop between the positive and negative terminals of the battery, and of accordingly controlling a battery recharge or discharge current.

According to an embodiment, the battery comprises no data communication link between the control circuits and the management unit.

According to an embodiment, the battery comprises no data communication link between the different control circuits.

According to an embodiment, each control circuit is capable of determining the direction of the current flowing at the intermediate node between the first and second switches of the interconnection circuit associated therewith.

According to an embodiment, each control circuit is capable of causing the turning off of the second switch and the turning on of the first switch when the current flowing at the intermediate node of the interconnection circuit associated therewith changes direction.

According to an embodiment, the management unit is capable of decreasing a battery recharge or discharge current when it detects the shunting of a unit.

According to an embodiment, the battery further comprises, associated with each unit, a regulation circuit capable of applying a predefined regulation voltage across the second switch of the interconnection circuit associated with the unit.

According to an embodiment, the regulation circuit is capable of placing the second switch in a partially on state to generate the regulation voltage.

According to an embodiment, each control circuit is capable of ordering the application of the regulation voltage across the second switch by the corresponding regulation circuit, when the voltage across the corresponding unit reaches a threshold and the current flowing through the second switch is lower than a threshold.

According to an embodiment, the first and second switches are MOS transistors.

The foregoing and other features and advantages will be discussed in detail in the following non-limiting description of dedicated embodiments in connection with the accompanying drawings.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is an electric diagram of an embodiment of an electric battery comprising an electronic management system; and

FIG. 2 is a partial electric diagram of another embodiment of an electric battery comprising an electronic management system.

### DETAILED DESCRIPTION OF THE PRESENT EMBODIMENTS

The same elements have been designated with the same reference numerals in the different drawings. Unless otherwise specified, expressions “approximately”, “subsantially”and “in the order of” mean to within 10%, preferably to within 5%. In the present description, term “connected” is used to designate a direct electric connection, with no intermediate electronic component, for example, by means of one or a plurality of conductive tracks and/or of a normally conductive fuse-type protection element and/or of one of a plurality of switches in the on state, and term “coupled” or term “linked” is used to designate either a direct electric connection (then meaning “connected”) or a connection via one or a plurality of intermediate components (resistor, diode, capacitor, etc.).

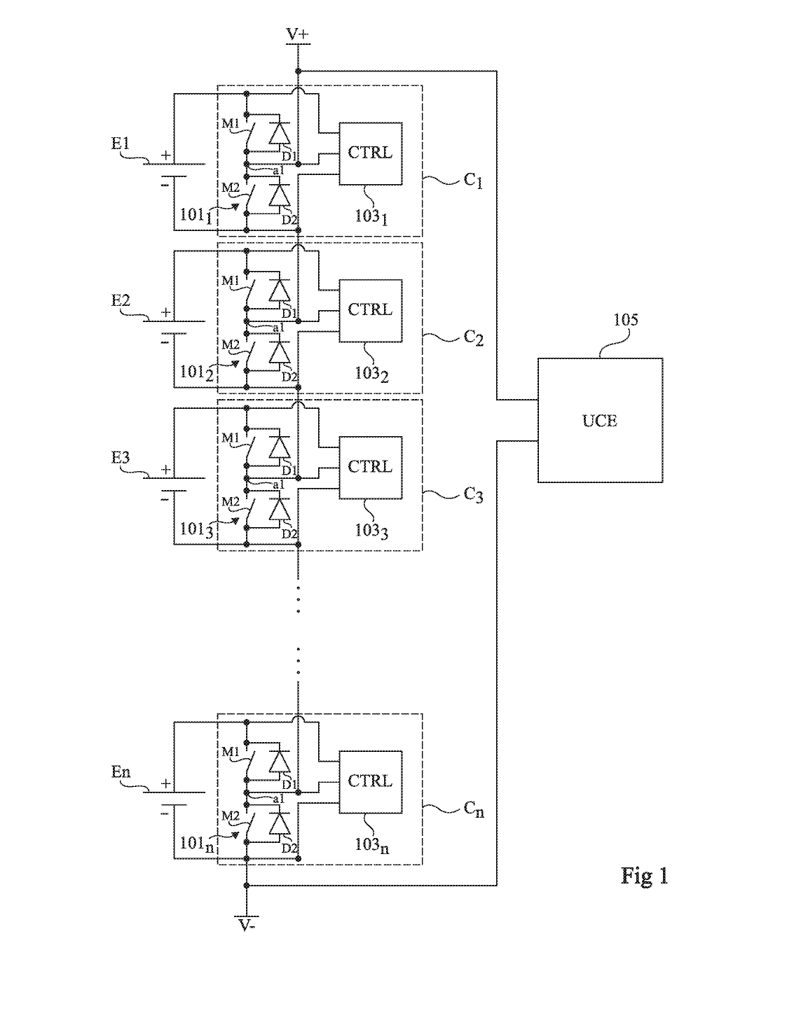

FIG. 1 is an electric diagram of an embodiment of an electric battery comprising a plurality of elementary rechargeable electrical energy storage cells and an electronic battery management system.

In this example, the battery comprises n rechargeable electrical energy storage units Ei, n being an integer, for example, greater than or equal to 3, and i being an integer in the range from 1 to n. Each unit Ei comprises one or a plurality of elementary electrical energy storage cells connected in series and/or in parallel between a positive terminal (+) and a negative terminal (−) of the unit. As an example, each unit Ei comprises a single elementary electrical energy storage cell. As a variation, each unit Ei comprises a plurality of elementary cells, for example, identical or similar, connected in parallel between the positive terminal and the negative terminal of the unit. The n units Ei of the battery are for example identical or similar.

In the battery of FIG. 1, units Ei are not directly connected two by two, but are coupled via controllable interconnection elements of the battery. More particularly, the battery of FIG. 1, comprises, associated with each unit Ei, a controllable interconnection circuit 101ᵢ comprising two switches M1 and M2 series-connected between the positive terminal (+) and the negative terminal (−) of the unit. Switch M1 is located on the side of the positive terminal (+) of the unit, that is, its conduction nodes are respectively connected to the positive terminal (+) of the unit and to an intermediate node a1 of the interconnection circuit. Switch M2 is located on the side of the negative terminal (−) of the unit, that is, its conduction nodes are respectively connected to the negative terminal (−) of the unit and to intermediate node a1 of interconnection circuit 101ᵢ. The switches M2 associated with the different units Ei of the battery are series-connected between a positive terminal V+ and a negative terminal V− of the battery. Such a battery cell interconnection mode has already been provided by the applicant in patent application FR2976743 filed on Jun. 17, 2011. In the example of FIG. 1, each interconnection circuit 101ᵢ further comprises a diode D1 connected in parallel with switch Ml, and a diode D2 connected in parallel with switch M2. Diode D2 is forward-connected between the negative terminal of unit Ei and node a1 of interconnection circuit 101ᵢ, and diode D1 is forward-connected between node al and the positive terminal of unit Ei. As an example, switches M1 and M2 are MOS transistors, diodes D1 and D2 being the intrinsic drain/source diodes of transistors M1 and M2, respectively.

In normal operation, switches M1 of the different interconnection circuits 101ᵢ of the battery are on (that is, in the conductive state), and switches M2 are off (that is, in the non-conductive state). Units Ei are then series-connected between positive and negative terminals V+ and V− for supplying the total battery voltage.

The battery of FIG. 1 further comprises, associated with each interconnection circuit 101ᵢ, a self-contained circuit 103ᵢ (CTRL) for controlling switches M1 and M2 of interconnection circuit 101ᵢ. Each control circuit 103ᵢ is connected to the positive and negative terminals of the corresponding unit Ei, as well as to the control terminals of switches M1 and M2 of the corresponding interconnection circuit 101ᵢ. For simplification, the connections between the control terminals of switches M1, M2 and control circuits 103ᵢ have not been shown in the drawings. Each control circuit 103ᵢ comprises a voltage sensor (not shown) capable of measuring the voltage across the corresponding unit Ei or, at least one sensor of the crossing of a threshold capable of detecting that the voltage across unit Ei reaches a predefined threshold. Control circuit 103ᵢ is capable of turning off switch M1 and of turning on switch M2 of interconnection circuit 101ᵢ when the voltage across unit Ei reaches a threshold, for example, a high threshold corresponding to a charged state of the unit, or a low threshold (lower than the high threshold) corresponding to a discharged state of the unit. Control circuit 103ᵢ is configured so that switches M1 and M2 are never simultaneously placed in the on state, which would short-circuit unit Ei and might damage the battery. Control circuit 103ᵢ may further comprise one or a plurality of additional sensors, for example, a temperature sensor, a current sensor, etc.

Self-contained circuit here means that control circuits 103ᵢ receive no information from a centralized control unit and do not communicate the output values of the sensor(s) that they comprise to a centralized control unit. In other words, no wire communication link or the like is provided between local control circuits 103ᵢ and a centralized control unit. The battery of FIG. 1 does not comprise a wire communication link or the like between the different local control circuits 103ᵢ either. Thus, the decision to switch switches M1 and M2 of an interconnection circuit 101ᵢ is taken locally by the corresponding control circuit 103ᵢ, by only taking into account the measurements performed by the sensor(s) of control circuit 103ᵢ. As an example, each control circuit 103ᵢ draws its power supply from the unit Ei across which it is connected.

When switches M1 and M2 associated with a unit Ei of the battery are respectively in the off state and in the on state, unit Ei is shunted or isolated from the rest of the battery, and no longer takes part in supplying the output voltage delivered between terminals V+ and V− of the battery. The battery output voltage then drops by a value substantially equal to the value of the voltage across unit Ei. However, the power path of the battery is not interrupted and the battery can keep on delivering or receiving power, the positive terminal of unit Ei+1 being connected to the negative terminal of unit Ei-1 via switch M1 of interconnection circuit 101_{i±1} and switch M2 of interconnection circuit 101ᵢ, both in the on state.

The battery of FIG. 1 further comprises an electronic control unit or management unit 105 (UCE). Management unit 105 is connected to positive terminal V+ and to negative terminal V− of the battery. Management unit 105 is however connected neither to intermediate nodes of the series association of units Ei, nor to the control nodes of switches M1 and M2 of interconnection circuits 101ᵢ, nor to control circuits 103ᵢ associated with interconnection circuits 101ᵢ. Management unit 105 is capable, when a storage unit Ei is shunted, of detecting a corresponding voltage drop between the positive and negative terminals V+ and V− of the battery, and of deducing therefrom that a unit Ei has been shunted. Management unit 105 comprises a voltage sensor (not shown) measuring the voltage across the battery, and may further comprise other sensors, for example a sensor of the current flowing between V+ and V− of the battery, a temperature sensor, etc. Management unit 105 further comprises a processing circuit (not shown), for example, a microcontroller, receiving the measurements performed by the sensor(s) of management unit 105. Management unit 105 is capable of controlling actions such as the decrease or the interruption of the battery recharge or discharge current.

An advantage of the configuration of FIG. 1 is that the length of cables internal to the battery is significantly decreased as compared with batteries where direct wire connections exist between each unit or interconnection or control circuit associated with the unit, and a centralized management unit. In the battery of FIG. 1, interconnection circuit 101ᵢ and control circuit 103ᵢ associated with each unit Ei may for example be arranged on a same printed circuit board Cᵢ solidly assembled to unit Ei, for example, screwed or welded to the positive and negative terminals of unit Ei. Thus, only two cables respectively connected to positive terminal V+ and to negative terminal V− of the battery connect management unit 105 to all the interconnection or control circuits associated with the different units Ei of the battery.

Examples of methods for controlling or managing the battery of FIG. 1 by means of the management system formed by interconnection circuits 101ᵢ, control circuits 103ᵢ, and management unit 105 during battery recharge and discharge phases will be described. All these control methods are based on the ability of management unit 105 to detect the shunting of a unit Ei by detection of a corresponding voltage drop between terminals V+ and V− of the battery.

### FIRST EXAMPLE

### Battery Recharge

During a battery recharge phase, a charger (not shown) applies a recharge current between negative terminal V− and positive terminal V+ of the battery, possibly via management unit 105. If the battery operates normally, switches M1 of interconnection circuits 101ᵢ all are in the on state, and switches M2 of interconnection circuits 101ᵢ all are in the off state, so that the recharge current flows through all units Ei of the battery. When the voltage of a first unit Ei reaches a predefined threshold corresponding to its full-charge voltage, the corresponding control circuit 103ᵢ detects it, and accordingly causes the turning-off of switch M1 and the turning-on of switch M2 of the interconnection circuit 101ᵢ associated with the unit. Unit Ei is then isolated from the rest of the battery, and the voltage across the battery drops by a value substantially equal to the voltage of unit Ei. Management unit 105 detects this voltage drop and can deduce therefrom that the end of the battery recharge phase is close. As an example, management unit 105 can then cause a decrease of the recharge current, so that the end of the recharge occurs under a lower current than the current applied during the beginning of the recharge phase. Each time a new unit Ei reaches its full charge voltage, the unit is shunted, and the voltage across the battery accordingly drops. When the voltage across the battery reaches a substantially zero value, for example, lower than 1 V, management unit 105 can deduce therefrom that all units Ei are charged, and accordingly interrupt the recharge current. The battery is then charged and balanced. Each control unit 103ᵢ is for example capable of detecting the end of the recharge, for example by means of a sensor of the current or of the sign of the current flowing at node a1 of the corresponding interconnection circuit 101ᵢ, and of accordingly causing the turning back off of switch M2 and the turning on of transistor M1 of interconnection circuit 101ᵢ, to connect back units Ei in series between terminals V+ and V− of the battery.

### SECOND EXAMPLE

### Battery Discharge

During a battery discharge phase, a current flows between positive terminal V+ and negative terminal V− of the battery through a load not shown, possibly via management unit 105. If the battery operates normally, switches M1 of interconnection circuits 101ᵢ all are in the on state, and switches M2 of interconnection circuits 101ᵢ all are in the off state, so that all units Ei of the battery take part in supplying the discharge current. When the voltage of a first unit Ei reaches a predefined threshold corresponding to its discharged state, the corresponding control circuit 103ᵢ detects it, and accordingly causes the turning off of switch M1 and the turning on of switch M2 of the interconnection circuit 101ᵢ associated with the unit. Unit Ei is then isolated from the rest of the battery, and the voltage across the battery drops by a value substantially equal to the voltage of unit Ei. Management unit 105 detects this voltage drop and can deduce therefrom that the battery is close to its discharged state. As an example, management unit 105 may then cause the interruption of the discharge current, and notify the user that the battery should be recharged. As a variation, the discharge may carry on for some time, for example, until a predefined number of units Ei (for example, the n units Ei of the battery) are discharged. Management unit 105 can then cause the interruption of the battery discharge current. Each control unit 103ᵢ is for example capable of detecting the end of the discharge phase, for example by means of a sensor of the current or of the sign of the current flowing at node a1 of the corresponding interconnection circuit 101ᵢ, and of accordingly causing the turning back off of switch M2 and the turning on of transistor M1 of the interconnection circuit, to connect back units Ei in series between terminals V+ and V− of the battery.

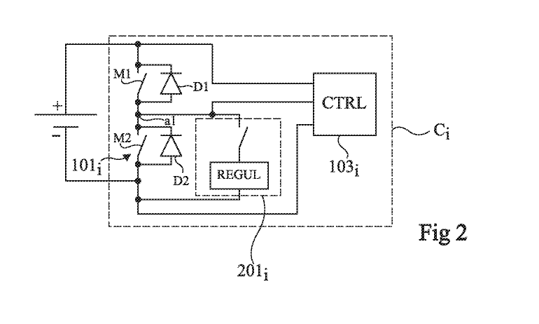

FIG. 2 is a partial electric diagram of an embodiment of an electric battery provided with an electronic management system. The battery of FIG. 2 comprises the same elements as the battery of FIG. 1, and differs from the battery of FIG. 1 mainly in that it further comprises, associated with each energy storage unit Ei of the battery, a regulation circuit 201ᵢ (REGUL) controllable by control circuit 103ᵢ, capable of regulating a predefined voltage between terminal a1 of interconnection circuit 101ᵢ and the negative terminal of unit Ei. The regulation circuit is for example arranged on the same printed circuit board Cᵢ as interconnection circuit 101ᵢ and control circuit 103ᵢ. For simplification, only one energy storage unit Ei, as well as interconnection, control, and regulation circuits 101ᵢ, 103ᵢ, and 201ᵢ associated with this unit, have been shown in FIG. 2.

As an example, switches M1 and M2 of interconnection circuit 101ᵢ are MOS transistors, and the regulation circuit is a circuit capable of placing transistor M2 in the linear state, that is, in a partially conductive state, to force between its main conduction terminal (source, drain) a predefined regulation voltage. Regulation circuit 201ᵢ may be supplied by the same energy source as control circuit 103ᵢ, for example, by the unit Ei associated therewith. As an example, regulation circuit 201ᵢ may be part of control circuit 103ᵢ.

Examples of methods of controlling the battery of FIG. 2 will be described. As for the battery of FIG. 1, all these control methods are based on the ability of management unit 105 to detect the shunting of a unit Ei by detection of a corresponding voltage drop between terminals V+ and V− of the battery.

### THIRD EXAMPLE

### Battery Recharge

During a battery recharge phase, a recharge current flows between negative terminal V− and positive terminal V+ of the battery, possibly via management unit 105. If the battery operates normally, switches M1 of interconnection circuits 101ᵢ all are in the on state, and switches M2 of interconnection circuits 101ᵢ all are in the off state, so that the recharge current flows through all units Ei of the battery. When the voltage of a first unit Ei reaches a predefined threshold corresponding to its full-charge voltage, the corresponding control circuit 103ᵢ detects it, and accordingly controls the turning off of switch M1 and the turning on of switch M2 of the interconnection circuit 101ᵢ associated with the unit. Unit Ei is then isolated from the rest of the battery, and the voltage across the battery drops by a value substantially equal to the voltage of unit Ei. Management unit 105 detects this voltage drop and can deduce therefrom that the end of the battery recharge is close. Management unit 105 then controls the decrease of the recharge current, so that the end of the recharge occurs under a lower current than the current applied during the rest of the recharge phase. Each control circuit 103ᵢ is capable of detecting that the battery is in end-of-charge state, that is, that it receives a decreased recharge current, by means of a sensor of the current flowing at node a1 of interconnection circuit 101ᵢ. As an example, control circuit 103ᵢ considers that the battery is in end-of-charge state when the current flowing at node a1 is lower than a threshold. When the voltage of a unit Ei is at its full charge threshold and the battery is in end-of-charge state, this is detected by control circuit 103ᵢ of the unit, which accordingly controls regulation circuit 201ᵢ so that it applies across switch M2 a predefined positive voltage V_{regul}, for example, greater than or equal to 1 V. Voltage V_{regul} is for example smaller than the full-charge voltage of unit Ei. In the case where regulation voltage V_{regul} would not be generated by switch M2 itself operating in a partially conductive state, but by another voltage source, switch M2 may be off during the regulation phase to avoid short-circuiting this voltage source. During the end of battery recharge phase, each time a new unit Ei reaches its full charge voltage, the unit is shunted, and voltage V_{regul} is applied between node a1 of interconnection circuit 101ᵢ and the negative terminal of unit Ei, as a substitution of the voltage of unit Ei. When the voltage across the battery reaches a value substantially equal to n*V_{regul}, for example, to within 0.5*V_{regul} and preferably to within 0.1*V_{regul}, where n is the number of units Ei of the battery, management unit 105 can deduce therefrom that all units Ei are charged, and accordingly interrupt the recharge current. The battery is then charged and balanced. Each control unit 103ᵢ is for example capable of detecting the end of the recharge, for example by means of a sensor of the current or of the sign of the current flowing at node a1 of the corresponding interconnection circuit 101ᵢ, and of accordingly causing the turning back off of switch M2 and the turning on of transistor M1 of the interconnection circuit, as well as the interruption of the voltage regulation by regulation circuit 201ᵢ, to connect back units Ei in series between terminals V+ and V− of the battery.

### FOURTH EXAMPLE

### Battery Discharge

During a battery discharge phase, a current flows between positive terminal V+ and negative terminal V− of the battery, possibly via management unit 105. If the battery operates normally, switches M1 of interconnection circuits 101ᵢ all are in the on state, and switches M2 of interconnection circuits 101ᵢ all are in the off state, so that all units Ei of the battery take part in supplying the discharge current. When the voltage of a first unit Ei reaches a predefined threshold corresponding to its discharged state, this is detected by the corresponding control circuit 103ᵢ, which accordingly controls the turning-off of switch M1 and the turning-on of switch M2 of the interconnection circuit 101ᵢ associated with the unit. Unit Ei is then isolated from the rest of the battery, and the voltage across the battery drops by a value substantially equal to the voltage of unit Ei. Management unit 105 detects this voltage drop and can deduce therefrom that the battery is close to its discharged state. Management unit 105 can then control the interruption of the discharge current, and notify the user that the battery should be recharged. As a variation, management unit 105 can control the decrease of the discharge current, so that the end of the discharge occurs under a current lower than the discharge current preceding the switching of first interconnection circuit 101ᵢ. Each control circuit 103ᵢ may be capable of detecting that the battery is in an end-of-discharge state, by means of a sensor of the current flowing at node a1 of the corresponding interconnection circuit 101ᵢ. As an example, control circuit 103ᵢ considers that the battery is in end-of-discharge state when the current flowing at node a1 is lower than a threshold. When the voltage of a unit Ei is at its discharge threshold and the battery is in end-of-discharge state, this is detected by control circuit 103ᵢ of the unit, which accordingly controls regulation circuit 201ᵢ so that it applies across switch M2 a positive regulation voltage V_{regul}, for example, lower than the voltage of unit Ei in the discharged state. All along the phase of end of discharge of the battery, each time a new unit Ei reaches its discharge voltage, the unit is shunted, and voltage V_{regul} is applied between node a1 of interconnection circuit 101ᵢ and the negative terminal of unit Ei, as a substitution of the voltage of unit Ei. When a predefined number n1 of units Ei has been shunted, with n1<n, management unit 105 interrupts the discharge current. Each control unit 103ᵢ is for example capable of detecting the end of the discharge phase, for example by means of a sensor of the current or of the sign of the current flowing at node a1 of the corresponding interconnection circuit 101ᵢ, and of accordingly causing the turning back off of switch M2 and the turning on of transistor M1 of the interconnection circuit, as well as the interruption of the voltage regulation by regulation circuit 201ᵢ, to connect back units Ei in series between terminals V+ and V− of the battery.

### FIFTH EXAMPLE

### Battery Recharge or Discharge

As a variation, if regulation units 201ᵢ are capable of regulating the voltage across switch M2 under a high recharge or discharge current, the end of the phase of battery recharge or discharge may be achieved without decreasing the recharge or discharge current. In this case, when the voltage of a first unit Ei reaches a predefined threshold corresponding to its full-charge voltage or to its discharge voltage, this is detected by the corresponding control circuit 103ᵢ, which accordingly controls the shunting of unit Ei. The regulation of the voltage across switch M2 may be simultaneously ordered, without waiting for a decrease of the battery recharge or discharge current.

An advantage of the embodiment of FIG. 2 is that the provision of regulation circuits 201ᵢ enables to keep a minimum voltage level all along the battery recharge and discharge phases, even when many units Ei are shunted. This enables to make the battery compatible with chargers or loads requiring seeing between their terminals a minimum voltage to operate properly.

In the embodiments of FIGS. 1 and 2, each control circuit 103ᵢ may further be capable of detecting a possible failure of the unit Ei associated therewith, for example, by detection of an abnormal voltage across the unit, or by detection of an abnormal rise of the unit temperature. Each control circuit 103ᵢ may be configured so as to, when it detects a failure of the unit Ei associated therewith, for example, during a battery recharge or discharge phase, or at any other time, cause the final turning off of switch M1 and the final turning on of switch M2. Final here means that the switches M1 and M2 associated with the defective unit Ei will not be switched again at the end of the next battery recharge or discharge phase. Thus, defective unit Ei will remain shunted until its possible replacing with a new unit. Management unit 105 may be capable of detecting, for example, after each battery recharge phase, whether the battery comprises defective units and how many units are defective. Indeed, after a battery recharge phase, when the non-defective units Ei are connected back in series between terminals V+ and V− of the battery, a voltage substantially equal to the sum of the voltages of the connected units Ei is established across the battery. Management unit 105 can then determine how many units Ei are series-connected between terminals V+ and V− of the battery, and deduce therefrom how many units have remained shunted (and are thus defective). The number of valid units of the battery may be stored by management unit 105. It should be noted that in the embodiment of FIG. 2, if a defective unit Ei is shunted during a battery recharge phase, it is possible for the voltage across the battery never to reach voltage n*V_{regul} enabling management unit 105 to know that the charge has ended. In this case, a timer may be provided to interrupt the battery recharge when management unit 105 detects that the voltage across the battery has remained stable for a given time, despite the application of a recharge current in the battery. Similar mechanisms of detection of the number of defective units may be provided during battery discharge phases.

In addition to simplifying the battery management system and decreasing the number of cables within the battery, the described embodiments have the advantage that the battery may keep on operating (with a decreased total capacitance) even when units Ei are defective.

Specific embodiments have been described. Various alterations, modifications, and improvements will occur to those skilled in the art. In particular, the described embodiments are not limited to the above-described examples of battery management methods. As a variation, each control circuit 103ᵢ may comprise a sensor of the temperature of the unit Ei associated therewith, and methods for managing the temperature within the battery may be implemented. For example, during different battery operating phases, if the temperature of a unit Ei of the battery comes out of a predefined operating range, control circuit 103ᵢ may actuate switches M1 and M2 to temporarily shunt unit Ei until its temperature returns to an appropriate value.

Further, management unit 105 may comprise elements and functionalities other than those which have been described. As an example, management unit 105 may implement a counting of the charges entering or coming out of the battery, via a sensor (not shown) of the current flowing between terminals V+ and V− of the battery, to detect a possible decrease of the total battery charge storage capacity.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An electric battery comprising:
a plurality of electrical energy storage units;
associated with each unit, an interconnection circuit comprising first and second switches series-connected between a positive terminal and a negative terminal of the unit, the second switches of the different interconnection circuits being series-connected between a positive terminal and a negative terminal of the battery;
associated with each interconnection circuit, a self-contained control circuit capable of causing the turning off of the first switch and the turning on of the second switch to shunt the unit when the voltage across the unit reaches a threshold; and
a management unit connected to the positive and negative terminals of the system, capable, when a unit is shunted, of detecting a corresponding voltage drop between the positive and negative terminals of the battery, and of accordingly controlling a battery recharge or discharge current.

2. The battery of claim 1, comprising no data communication link between the control circuits and the management unit.

3. The battery of claim 1, comprising no data communication link between the different control circuits.

4. The battery of claim 1, wherein each control circuit is capable of determining the direction of the current flowing at the intermediate node between the first and second switches of the interconnection circuit associated therewith.

5. The battery of claim 4, wherein each control circuit is capable of causing the turning off of the second switch and the turning on of the first switch when the current flowing at the intermediate node of the interconnection circuit associated therewith changes direction.

6. The battery of claim 1, wherein the management unit is capable of decreasing a battery recharge or discharge current when it detects the shunting of a unit.

7. The battery of claim 1, further comprising, associated with each unit, a regulation circuit capable of applying a predefined regulation voltage across the second switch of the interconnection circuit associated with the unit.

8. The battery of claim 7, wherein the regulation circuit is capable of placing the second switch in a partially on state to generate the regulation voltage.

9. The battery of claim 7, wherein each control circuit is capable of ordering the application of the regulation voltage across the second switch by the corresponding regulation circuit, when the voltage across the corresponding unit reaches a threshold and the current flowing through the second switch is lower than a threshold.

10. The battery of claim 1, wherein the first and second switches are MOS transistors.
